(19) United States
(12) Patent Application Publication
(10) Pub. No.: US 2021/0103086 A1
(43) Pub. Date: Apr. 8, 2021

(54) PLANAR ILLUMINATION DEVICE

(71) Applicant: MINEBEA MITSUMI Inc., Nagano (JP)

(72) Inventors: Taku YAMADA, Nagano (JP); Kenta OISHI, Nagano (JP)

(21) Appl. No.: 16/605,037

(22) PCT Filed: Mar. 13, 2018
(86) PCT No.: PCT/JP2018/009794

§ 371 Date: Oct. 14, 2019

(30) Foreign Application Priority Data
Apr. 21, 2017 (JP) 2017-084521
Jul. 20, 2017 (JP) 2017-140760

(51) Int. Cl. F21V 8/00; B60Q 3/62; B60Q 3/80

(52) U.S. Cl. CPC G02B 6/0036; B60Q 3/80; B60Q 3/62; G02B 6/0048

(57) ABSTRACT

A planar illumination device according to an embodiment includes a light source and a light guide plate. The light source emits light in a predetermined direction. The light guide plate includes a side surface, an emission surface as one of principal surfaces, and a back surface as the other principal surface, the back surface including a prism formed thereon, the prism emitting, through an emission surface, light emitted from the light source and entered from the side surface. The prism includes, at a section parallel to the predetermined direction, a first region substantially parallel to the emission surface and a second region tilted relative to the emission surface, the first region and the second region extending in a direction oblique to the predetermined direction.

### FIELD

The present invention relates to a planar illumination device.

### BACKGROUND

Conventionally, a planar illumination device for in-vehicle illumination of lower parts of the driver seat and the passenger seat in an automobile has been provided. Recently, there is a need for a planar illumination device further having the translucent property to allow visual recognition through the planar illumination device.

### CITATION LIST

### Patent Literature

Patent Literature 1: Japanese Patent Application Laid-open No. 2010-105563

### SUMMARY

### Technical Problem

However, it has been difficult to achieve a translucent planar illumination device having a high light distribution property while maintaining the translucent property. As a result, light is emitted not only to lower parts of the driver seat and the passenger seat but also to the driver and a person seated on the passenger seat, and provides dazzling feeling to the driver and the person seated on the passenger seat in some cases.

The present invention is intended to solve the above-described problem and provide a planar illumination device that can achieve both a translucent property and a high light distribution property.

### Solution to Problem

### Advantageous Effects of Invention

According to an aspect of the present invention, both a translucent property and a high light distribution property can be achieved.

### BRIEF DESCRIPTION OF DRAWINGS

FIG. 1A is a front view of a planar illumination device according to an embodiment.

FIG. 1B is a cross-sectional view taken along line A-A in FIG. 1A.

FIG. 2A is an enlarged view of Region D in FIG. 1A.

FIG. 2B is an enlarged view of Region E in FIG. 1A.

FIG. 2C is a cross-sectional view taken along line F-F in FIG. 2A.

FIG. 3A is a diagram for describing a light bar according to the embodiment.

FIG. 3B is an enlarged view of the light bar according to the embodiment.

FIG. 3C is an enlarged view of Region H in FIG. 3A.

FIG. 3D is an enlarged view of Region J in FIG. 3A.

FIG. 3E is a cross-sectional view taken along line K-K in FIG. 3A.

FIG. 4A is an enlarged view of a central part of a prism sheet according to the embodiment in the longitudinal direction thereof.

FIG. 4B is an enlarged view of the vicinity of an end part of the prism sheet according to the embodiment in the longitudinal direction.

FIG. 5A is a diagram for describing a visual field control film according to the embodiment.

FIG. 5B is a diagram for describing another example of the visual field control film according to the embodiment.

FIG. 6A is a front view of the planar illumination device according to a first modification of the embodiment.

FIG. 6B is an enlarged view of Region M in FIG. 6A.

FIG. 7A is an enlarged view of a first light guiding portion according to a second modification of the embodiment.

FIG. 7B is an enlarged view of a second light guiding portion according to the second modification of the embodiment.

FIG. 8 is a cross-sectional view of the planar illumination device according to a third modification of the embodiment.

FIG. 9 is a diagram for describing a visual field control film according to the third modification of the embodiment.

FIG. 10A is a diagram for describing light distribution in the planar illumination device according to a reference example.

FIG. 10B is a diagram for describing light distribution in the planar illumination device according to the third modification of the embodiment.

FIG. 11 is a cross-sectional view of the planar illumination device according to a fourth modification of the embodiment.

FIG. 12 is a diagram illustrating light distribution in the planar illumination device according to the reference example.

FIG. 13 is a diagram for describing an azimuth angle in the light distribution illustrated in FIG. 12.

FIG. 14 is a diagram for describing a polar angle in the light distribution illustrated in FIG. 12.

FIG. 15 is a diagram illustrating light distribution sections in the embodiment, the third modification, the fourth modification, and the reference example.

### DESCRIPTION OF EMBODIMENTS

The following describes a planar illumination device according to an embodiment with reference to the accompanying drawings. The embodiment described below does not limit usage of the planar illumination device. The drawings are schematic, and for example, the dimensional relation between components and the ratio of the components may be different from those in reality in some cases. In addition, part of the dimensional relation and the ratio may be different between the drawings in some cases.

### Embodiment

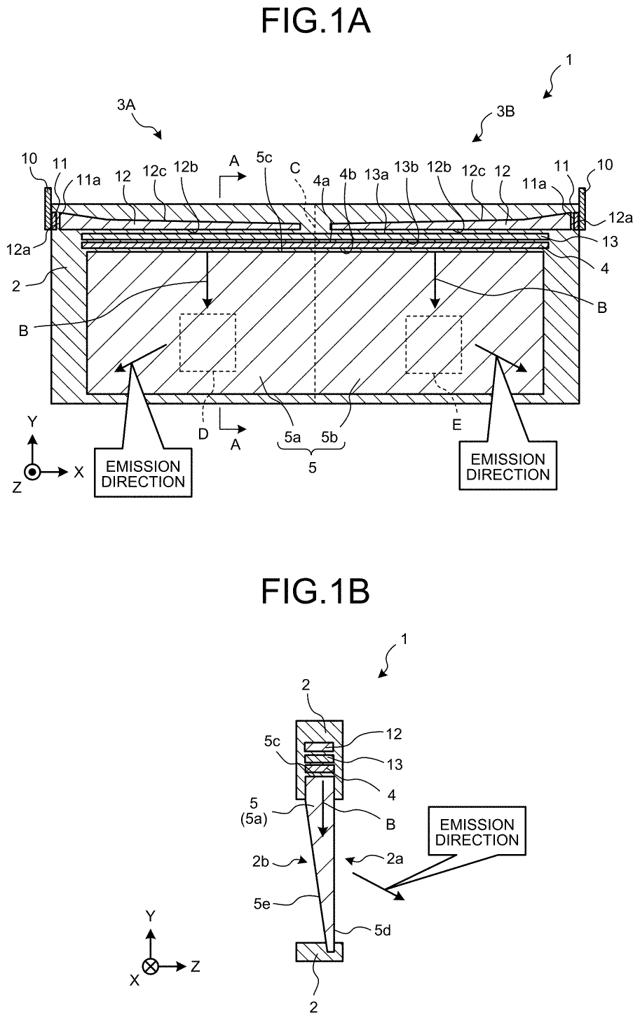

First, the outline of a planar illumination device 1 according to the embodiment will be described with reference to FIGS. 1A and 1B. FIG. 1A is a front view of the planar illumination device 1 according to the embodiment, and FIG. 1B is a cross-sectional view taken along line A-A in FIG. 1A.

As illustrated in FIG. 1A, the planar illumination device 1 includes a housing frame 2, linear light sources 3A and 3B, a visual field control film 4, and a light guide plate 5. The planar illumination device 1 is applied to, for example, an in-vehicle illumination lamp for illumination of lower parts of a driver seat and a passenger seat of an automobile.

The housing frame 2 holds and houses the linear light sources 3A and 3B, the visual field control film 4, and the light guide plate 5. The housing frame 2 is made of, for example, synthesis resin or metal. As illustrated in FIG. 1B, the housing frame 2 has an opening 2a formed on a principal surface 5d side of the light guide plate 5 and an opening 2b formed on a principal surface 5e side of the light guide plate 5, and the light guide plate 5 is exposed through the openings 2a and 2b. For the purpose of simplicity, FIG. 1A omits illustration of part of the housing frame 2 on the Z-axis positive direction side at places where the linear light sources 3A and 3B and the visual field control film 4 are disposed.

As illustrated in FIGS. 1A and 1B, the linear light source 3A is, for example, a light source configured to emit light on the passenger seat side (the lower-left side in FIG. 1A) in the vehicle, and the linear light source 3B is, for example, a light source configured to emit light on the driver seat side (the lower-right side in FIG. 1A) in the vehicle. The linear light sources 3A and 3B include a pair of flexible printed circuits (FPCs) 10, a pair of light emitting diodes (LEDs) 11, a pair of light bars 12, and one prism sheet 13.

Each FPC 10 is a substrate on which the corresponding LED 11 is mounted. The FPC 10 includes a mount surface on which the LED 11 can be mounted, and the mount surface is joined with a surface of the LED 11 opposite to a light emission surface 11a.

The pair of FPCs 10 are each connected with a drive circuit (not illustrated). Each LED 11 is driven by the drive circuit through the corresponding FPC 10, and accordingly, the corresponding one of the linear light sources 3A and 3B is turned on.

The LED 11 is a point light source. The LED 11 includes the light emission surface 11a through which light is emitted, and is disposed on a light incident surface 12a side of the light bar 12 while the light emission surface 11a faces the light incident surface 12a of the corresponding light bar 12. The LED 11 emits light from the light emission surface 11a toward the light incident surface 12a of the light bar 12.

As described above, the surface of the LED 11 opposite to the light emission surface 11a is joined with the FPC 10. Specifically, the LED 11 is a top-view LED in which the FPC 10 mounted thereon is substantially parallel to the light emission surface 11a. The LED 11 is not limited to the top-view LED but may be a side-view LED in which the FPC 10 mounted thereon is orthogonal to the light emission surface 11a.

The light bar 12 converts incident light from the LED 11 as a point light source into linear light, and emits the linear light toward the prism sheet 13. The light bar 12 is made of a transparent material (for example, polycarbonate resin) and formed in a bar shape, and includes the light incident surface 12a, a light outputting surface 12b, and an opposite light outputting surface 12c opposite to the light outputting surface 12b.

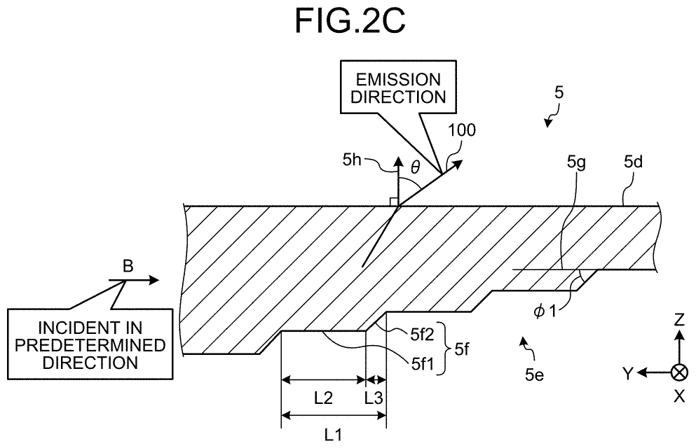

The light incident surface 12a is one end face of the light bar 12 on which light emitted from the LED 11 is incident. The light outputting surface 12b is a surface substantially orthogonal to the light incident surface 12a, from which incident light is emitted. A plurality of prisms 12j (refer to FIG. 3E) are formed side by side on the light outputting surface 12b. The opposite light outputting surface 12c is a surface opposite to the light outputting surface 12b, on which a plurality of prisms 12g (refer to FIG. 3C) are formed side by side. The light bar 12 will be described later in detail.

The prism sheet 13 controls light distribution. The prism sheet 13 is disposed between the light outputting surface 12b of the light bar 12 and a light incident surface 4a of the visual field control film 4. The prism sheet 13 includes a light incident surface 13a facing the light outputting surface 12b of the light bar 12, and a light outputting surface 13b opposite to the light incident surface 13a.

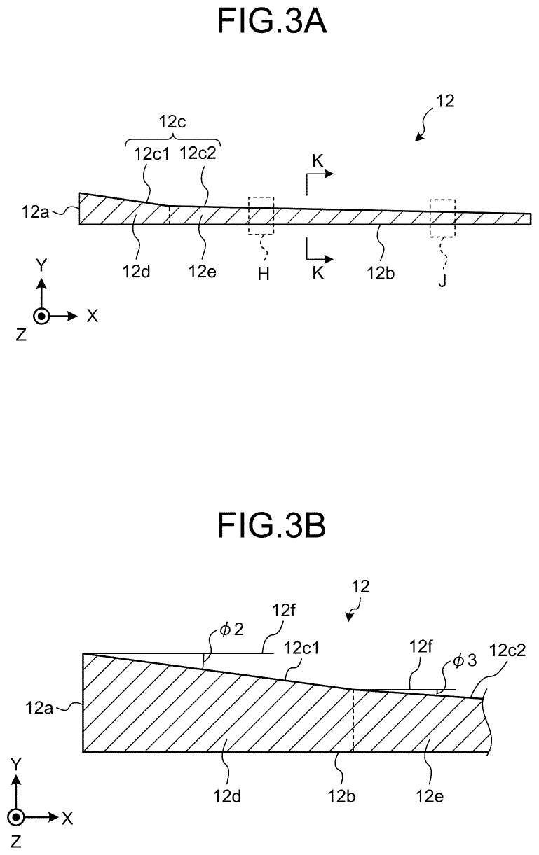

A plurality of prisms 13d (refer to FIG. 4A) are formed side by side on the light incident surface 13a. In addition, convex lenses 13e (refer to FIG. 4A) are formed side by side on the light outputting surface 13b. The prism sheet 13 will be described later in detail.

The linear light sources 3A and 3B described so far emit linear light in a predetermined direction B (the Y-axis negative direction in the drawings) from the light outputting surface 13b of the prism sheet 13 to a side surface 5c of the light guide plate 5 through the visual field control film 4. The linear light sources 3A and 3B configured to emit linear light in this manner can be used to emit planar light from the light guide plate 5.

The visual field control film 4 controls the light distribution angle of light. The visual field control film 4 is disposed between the light outputting surface 13b of the prism sheet 13 and the side surface 5c of the light guide plate 5. The visual field control film 4 includes the light incident surface 4a facing the light outputting surface 13b of the prism sheet 13, and a light outputting surface 4b opposite to the light incident surface 4a. The visual field control film 4 will be described later in detail.

The light guide plate 5 is formed in a rectangular shape in top view, and includes a first light guiding portion 5a that light emitted from the linear light source 3A enters, and a second light guiding portion 5b that light emitted from the linear light source 3B enters. The planar illumination device 1 according to the embodiment is formed linearly symmetrical with respect to Center C illustrated in FIG. 1A, and the light guide plate 5 is divided into the first light guiding portion 5a and the second light guiding portion 5b with Center C as the boundary therebetween.

As illustrated in FIG. 1B, the light guide plate 5 includes the side surface 5c facing the visual field control film 4, the principal surface 5d, and the principal surface 5e opposite to the principal surface 5d. The side surface 5c is a strip-shaped surface extending in the X-axis direction. Light traveling in the predetermined direction B is entered from the side surface 5c. The light guide plate 5 has, at a section parallel to the predetermined direction B, a wedge shape in which the thickness gradually decreases toward the predetermined direction B. In other words, the interval between the principal surface 5d and the principal surface 5e of the light guide plate 5 decreases toward a direction departing from the visual field control film 4.

The principal surfaces 5d and 5e are rectangular surfaces extending along the XY plane. The principal surface 5d is an emission surface from which light incident through the side surface 5c is emitted. Thus, in the following description, the principal surface 5d is referred to as “the emission surface 5d”. The principal surface 5e on the back side is referred to as “the back surface 5e”.

The light guide plate 5 is made of a transparent material (for example, polycarbonate resin) and has a desired translucent property. For example, the light guide plate 5 is entirely transparent so that an object on the back surface 5e side can be visually recognized from the emission surface 5d side through the openings 2a and 2b of the housing frame 2.

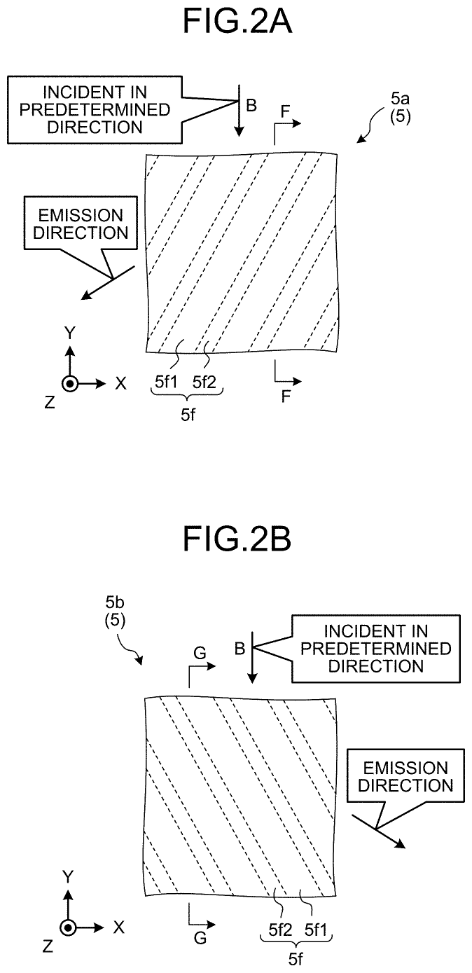

As illustrated in FIG. 1B, the emission surface 5d is disposed substantially parallel to the predetermined direction B. The back surface 5e is disposed at a tilt relative to the predetermined direction B. A plurality of prisms 5f (refer to FIG. 2A) are disposed side by side on the back surface 5e. The prisms 5f formed on the light guide plate 5 will be described in detail below with reference to FIGS. 2A to 2C.

FIG. 2A is an enlarged view of Region D in FIG. 1A, and FIG. 2B is an enlarged view of Region E in FIG. 1A. In other words, FIG. 2A is an enlarged view of the first light guiding portion 5a that light from the linear light source 3A enters, and FIG. 2B is an enlarged view of the second light guiding portion 5b that light from the linear light source 3B enters.

FIG. 2C is a cross-sectional view taken along line F-F in FIG. 2A, and specifically, a cross-sectional view of the light guide plate 5 at a section parallel to the predetermined direction B. FIG. 2C corresponds to a section taken along line G-G in FIG. 2B.

As illustrated in FIG. 2C, the prisms 5f are formed side by side in the predetermined direction B on the back surface 5e of the light guide plate 5. Each prism 5f includes a first region 5f1 and a second region 5f2.

The first region 5f1 has a substantially flat plate shape, and as illustrated in FIG. 2C, is substantially parallel to the emission surface 5d at a section of the light guide plate 5 parallel to the predetermined direction B. The second region 5f2 has a substantially flat plate shape, and is tilted relative to the emission surface 5d at a section of the light guide plate 5 parallel to the predetermined direction B. Specifically, the second region 5f2 is tilted in a direction approaching the emission surface 5d toward the predetermined direction B. The second region 5f2 of one prism 5f is formed continuously with the first region 5f1 of an adjacent prism 5f.

As illustrated in FIG. 2C, the prisms 5f each having such a sectional shape change the traveling path of light emitted in the predetermined direction B from the linear light sources 3A and 3B, and emit the light through the emission surface 5d. Specifically, light is reflected at the second region 5f2 of each prism 5f toward the emission surface 5d. In this manner, the light distribution in the Z-axis direction can be controlled by the prisms 5f.

Since the first region 5f1 and the emission surface 5d are substantially parallel to each other at a section of the light guide plate 5 parallel to the predetermined direction B, high physical continuity can be obtained for an object on the back surface 5e side when visually recognized from the emission surface 5d side. In other words, since the first region 5f1 and the emission surface 5d are substantially parallel to each other, distortion of the visually recognized object can be reduced. Accordingly, the light guide plate 5 has a high translucent property.

Moreover, since the first region 5f1 is substantially parallel to the emission surface 5d at a section parallel to the predetermined direction B, an angle θ of light 100 emitted when light incident in the predetermined direction B is reflected at the first region 5f1 can be prevented from shifting from the predetermined direction B to the Z-axis direction. Thus, it is possible to accurately control light distribution through the light guide plate 5 in the Z-axis direction.

In the embodiment, as illustrated in FIGS. 2A and 2B, the first region 5f1 and the second region 5f2 of each prism 5f extend in a direction oblique to the predetermined direction B. Specifically, in the first light guiding portion 5a illustrated in FIG. 2A, the first region 5f1 and the second region 5f2 extend from the X-axis negative direction and the Y-axis negative direction toward the X-axis positive direction and the Y-axis positive direction.

In the second light guiding portion 5b illustrated in FIG. 2B, the first region 5f1 and the second region 5f2 extend from the X-axis positive direction and the Y-axis negative direction toward the X-axis negative direction and the Y-axis positive direction.

In this manner, when the prisms 5f are formed to extend in the directions oblique to the predetermined direction B, as illustrated in FIGS. 2A and 2B, the traveling path of light emitted in the predetermined direction B from the linear light sources 3A and 3B can be changed to emit the light on the changed traveling path through the emission surface 5d.

Specifically, as illustrated in FIG. 2A, light is emitted toward the X-axis negative direction and the Y-axis negative direction in the first light guiding portion 5a, and as illustrated in FIG. 2B, light is emitted toward the X-axis positive direction and the Y-axis negative direction in the second light guiding portion 5b. In other words, light is emitted from the light guide plate 5 toward directions departing from the visual field control film 4 and approaching both ends at which the LEDs 11 are provided. In this manner, light distribution in the X-axis direction can be accurately controlled through the prisms 5f.

As described so far, in the planar illumination device 1 according to the embodiment, light distribution in the Z-axis direction and the X-axis direction (light distribution in two axis directions orthogonal to each other on the emission surface 5d of the light guide plate 5) can be accurately controlled through the prisms 5f formed on the light guide plate 5. In addition, in the planar illumination device 1, the light guide plate 5 has a high translucent property as described above. In other words, the embodiment can achieve both a translucent property and a high light distribution property.

In the embodiment, light may be emitted from the light guide plate 5 in the range of 40° or less at full width at half maximum. Accordingly, it is possible to sufficiently irradiate a necessary region (for example, a lower part of the driver seat) and further reduce irradiation of an unnecessary region (for example, the driver).

In the embodiment, the first region 5f1 and the emission surface 5d do not need to be completely parallel to each other at a section of the light guide plate 5 parallel to the predetermined direction B. For example, the first region 5f1 may have an angle of 0° to 5° inclusive to the emission surface 5d. The first region 5f1 preferably has an angle of 0° to 1° inclusive to the emission surface 5d, and more preferably an angle of 0° to 0.5° inclusive to the emission surface 5d.

In the embodiment, as illustrated in 1B, since the entire light guide plate 5 has a wedge shape in a sectional view along the YZ plane, the first region 5f1 and the emission surface 5d are not parallel to each other at a section of the light guide plate 5 in a direction different from the predetermined direction B.

In the embodiment, the ratio of a length L2 of the first region 5f1 in the Y-axis direction (which is the predetermined direction B) relative to a length L1 of each prism 5f in the Y-axis direction is equal to or higher than 60% and lower than 100% as illustrated in FIG. 2C. The length L1 is the sum of the length L2 and a length L3 of the second region 5f2 in the Y-axis direction.

In a sectional view along the YZ plane, a prism angle ϕ1 between the second region 5f2 and a surface 5g parallel to the emission surface 5d is given by Expression (1) below.

ϕ1={90−a sin(sin θ/n)}/2(°) (1)

In Expression (1) above, the angle θ is the angle (emission angle) between a direction 5h orthogonal to the emission surface 5d and the light 100 emitted from the emission surface 5d. The value n is the refractive index of the light guide plate 5.

In other words, when the prism angle ϕ1 of the prism 5f is set to a predetermined angle, only hands of the driver and a person seated on the passenger seat can be illuminated by the planar illumination device 1 applied to an in-vehicle illumination lamp for illumination of lower parts of the driver seat and the passenger seat. Accordingly, it is possible to reduce dazzling feeling given to the driver and the person seated on the passenger seat.

A plurality of rays of the light 100 are emitted in a plurality of directions from the emission surface 5d, and the angle θ is the angle between a direction in which a ray of the light 100 having a peak intensity among the rays of the light 100 travels and the direction 5h orthogonal to the emission surface 5d.

The following describes in detail the linear light sources 3A and 3B and the visual field control film 4 according to the embodiment. First, the light bars 12 of the linear light sources 3A and 3B will be described with reference to FIGS. 3A to 3E. FIG. 3A is a diagram for describing each light bar 12 according to the embodiment.

As illustrated in FIG. 3A, the width (dimension in the Y-axis direction) of the light bar 12 decreases as the position moves from one end at which the light incident surface 12a is provided toward the other end in the longitudinal direction (the X-axis direction in the drawing). The light bar 12 includes a base part 12d including the light incident surface 12a, and a leading end part 12e provided away from the light incident surface 12a.

The base part 12d and the leading end part 12e are formed so that the degree of tilt of the opposite light outputting surface 12c is different therebetween. Specifically, as illustrated in FIG. 3B, an angle ϕ2 between an opposite light outputting surface 12cl provided to the base part 12d and a surface 12f parallel to the light outputting surface 12b is larger than an angle ϕ3 between an opposite light outputting surface 12c2 provided to the leading end part 12e and the surface 12f parallel to the light outputting surface 12b.

In other words, the light bar 12 has a two-stage wedge shape in which the degree of tilt of the opposite light outputting surface 12cl provided to the base part 12d is larger than that of the opposite light outputting surface 12c2 provided to the leading end part 12e.

The following describes the prisms 12g formed on the opposite light outputting surface 12c of the light bar 12 in detail with reference to FIGS. 3C and 3D. FIG. 3C is an enlarged view of Region H in FIG. 3A, and FIG. 3D is an enlarged view of Region J in FIG. 3A. In other words, FIG. 3C is a diagram for describing the prisms 12g formed in Region H of the leading end part 12e close to the base part 12d, and FIG. 3D is a diagram for describing the prisms 12g formed in Region J of the leading end part 12e departed from the base part 12d.

As illustrated in FIG. 3C, the prisms 12g are formed side by side in the longitudinal direction (the X-axis direction) of the light bar 12 on the opposite light outputting surface 12c in Region H. Each prism 12g includes a tilt surface 12g1 and a tilt surface 12g2.

The tilt surface 12g1 is tilted in a direction departing from the light outputting surface 12b as the position moves from one end (the light incident surface 12a side) of the light bar 12 toward the other end. The tilt surface 12g2 is tilted in a direction approaching the light outputting surface 12b as the position moves from one end (the light incident surface 12a side) of the light bars 12 toward the other end. The tilt surface 12g2 of one prism 12g is formed continuously with the tilt surface 12g1 of an adjacent prism 12g.

In addition, as illustrated in FIG. 3D, the prisms 12g are formed side by side in the longitudinal direction (the X-axis direction) of the light bar 12 on the opposite light outputting surface 12c in Region J.

In a sectional view along the XY plane, an angle ϕ4 between the tilt surface 12g2 of each prism 12g in Region H illustrated in FIG. 3C and the surface 12f parallel to the light outputting surface 12b is smaller than an angle ϕ5 between the tilt surface 12g2 of the prism 12g in Region J illustrated in FIG. 3D and the surface 12f parallel to the light outputting surface 12b. In other words, the angle between the tilt surface 12g2 of the prism 12g and the surface 12f parallel to the light outputting surface 12b continuously changes so as to gradually increasing as the position moves from one end (the light incident surface 12a side) of the light bar 12 toward the other end.

In a sectional view along the XY plane, on the other hand, an angle ϕ6 between the tilt surface 12g1 and the tilt surface 12g2 is common to all prisms 12g. The prisms 12g as described so far enables controlling light distribution in the X-axis direction on the light outputting surface 12b of the light bar 12 accurately.

The following describes the prisms 12j formed on the light outputting surface 12b of the light bar 12 with reference to FIG. 3E. FIG. 3E is a cross-sectional view taken along line K-K in FIG. 3A. FIG. 3E illustrates side surfaces 12k and 12m of the light bar 12, which are substantially parallel to the XY plane.

As illustrated in FIG. 3E, in a sectional view along the YZ plane, the prisms 12j are formed side by side in the transverse direction (Z-axis direction) of the light bar 12 on the light outputting surface 12b of the light bar 12. Each prism 12j includes a tilt surface 12j1 and a tilt surface 12j2.

The tilt surface 12j1 is tilted in a direction departing from a surface 12h parallel to the light outputting surface 12b as the position moves from one end (the side surface 12k side) of the light bar 12 in the transverse direction toward the other end (side surface 12m side). The tilt surface 12j2 is tilted in the direction approaching the surface 12h parallel to the light outputting surface 12b as the position moves from one end (the side surface 12k side) of the light bar 12 in the transverse direction toward the other end (side surface 12m side).

A vertex angle ϕ7 between the tilt surface 12j1 and the tilt surface 12j2 (vertex angle of the prism 12j) is, for example, 90°. An angle ϕ8 between the tilt surface 12j1 and the surface 12h and an angle ϕ9 between the tilt surface 12j2 and the surface 12h are, for example, 45°.

The traveling path of light 101 entered into the light bar 12 can be changed through the prism 12j to a direction parallel to the Y-axis direction as illustrated in FIG. 3E so that the light 101 is entered from the light incident surface 13a of the prism sheet 13. In this manner, light distribution in the Z-axis direction can be accurately controlled through the prisms 12j.

In addition, light distribution in the X-axis direction can be controlled through the prisms 12g formed on the opposite light outputting surface 12c as described above. In other words, light distribution in the X-axis direction and the Z-axis direction can be accurately controlled in the light bar 12 according to the embodiment.

When the vertex angle ϕ7 of each prism 12j is 90°, the angle of light distribution in the Z-axis direction at the emission surface 5d of the light guide plate 5 is smallest. When the vertex angle ϕ7 is larger than 90°, light distribution in the Z-axis direction at the emission surface 5d of the light guide plate 5 can be widened.

The following describes the prism sheet 13 according to the embodiment in detail with reference to FIGS. 4A and 4B. FIG. 4A is an enlarged view of a central part of the prism sheet 13 according to the embodiment in the longitudinal direction (the X-axis direction).

As illustrated in FIG. 4A, the prisms 13d are formed side by side in the longitudinal direction (the X-axis direction) of the prism sheet 13 on the light incident surface 13a at the central part of the prism sheet 13. Each prism 13d includes a tilt surface 13d1 and a tilt surface 13d2.

The tilt surface 13d1 is tilted in a direction departing from the light outputting surface 13b as the position moves from one end (the X-axis negative direction side) of the prism sheet 13 in the longitudinal direction toward the other end (the X-axis positive direction side). The tilt surface 13d2 is tilted in a direction approaching the light outputting surface 13b as the position moves from one end (the X-axis negative direction side) of the prism sheet 13 in the longitudinal direction toward the other end (the X-axis positive direction side). The tilt surface 13d2 of one prism 13d is formed continuously with the tilt surface 13d1 of an adjacent prism 13d.

As illustrated in FIG. 4A, the traveling path of light 102 entered into the prism sheet 13 can be changed through the prism 13d to a direction parallel to the Y-axis direction so that the light 102 is entered from the light incident surface 4a of the visual field control film 4. For example, the light 102 entered from the tilt surface 13d1 of the prism 13d is reflected toward the light incident surface 4a through the tilt surface 13d2. In this manner, light distribution in the X-axis direction can be controlled through the prisms 13d.

FIG. 4B is an enlarged view of the vicinity of an end part of the prism sheet 13 according to the embodiment in the longitudinal direction, specifically, an enlarged view of the vicinity of the end part on the linear light source 3A side. As illustrated in FIG. 4B, the prisms 13d are also formed side by side in the longitudinal direction (the X-axis direction) of the prism sheet 13 on the light incident surface 13a in the vicinity of the end part.

The shape of each prism 13d in a sectional view along the XY plane is line symmetric with respect to a line segment passing through Center C of the planar illumination device 1. In other words, the prisms 13d between which the tilt surface 13d1 tilted in the direction departing from the light outputting surface 13b and the tilt surface 13d2 tilted in the direction approaching the light outputting surface 13b are continuous with each other are formed side by side in the X-axis direction on the light incident surface 13a as the position moves from both ends of the prism sheet 13 in the X-axis direction toward Center C.

As illustrated in FIG. 4B, the traveling path of light 103 entered into the prism sheet 13 can be changed through the prisms 13d to a direction parallel to the Y-axis direction so that the light 103 is entered from the light incident surface 4a of the visual field control film 4.

In a sectional view along the XY plane, an angle ϕ10 between the tilt surface 13d1 of each prism 13d and a surface 13f parallel to the light outputting surface 13b at the central part of the prism sheet 13 illustrated in FIG. 4A is smaller than an angle ϕ13 between the tilt surface 13d1 of the prism 13d and the surface 13f in the vicinity of the end part of the prism sheet 13 illustrated in FIG. 4B.

In other words, the tilt angle (angle ϕ10) of the tilt surface 13d1 formed at the central part of the light incident surface 13a is smaller than the tilt angle (angle ϕ13) of the tilt surface 13d1 formed in the vicinity of the end part of the light incident surface 13a.

In a sectional view along the XY plane, an angle ϕ11 between the tilt surface 13d2 of each prism 13d and the surface 13f parallel to the light outputting surface 13b at the central part of the prism sheet 13 illustrated in FIG. 4A is larger than an angle 414 between the tilt surface 13d2 of the prism 13d and the surface 13f in the vicinity of the end part of the prism sheet 13 illustrated in FIG. 4B.

In other words, the tilt angle (angle ϕ11) of the tilt surface 13d2 formed at the central part of the light incident surface 13a is larger than the tilt angle (angle ϕ14) of the tilt surface 13d2 formed in the vicinity of the end part of the light incident surface 13a.

In a sectional view along the XY plane, on the other hand, an angle 412 between the tilt surface 13d1 and the tilt surface 13d2 is common to all prisms 13d.

In the prism 13d positioned at Center C in a sectional view along the XY plane, the angle 410 between the tilt surface 13d1 and the surface 13f is equal to the angle ϕ11 between the tilt surface 13d2 and the surface 13f. In other words, the shape of the prism 13d positioned at Center C is an isosceles triangle in a sectional view along the XY plane.

As described above, the shape of the prisms 13d in a sectional view along the XY plane is line symmetric with respect to the line segment passing through Center C of the planar illumination device 1. Accordingly, when the pair of LEDs 11 emit light in directions different from each other, the direction of the light can be aligned with the predetermined direction B through the prism sheet 13.

The light outputting surface 13b of the prism sheet 13 may have a flat plate shape or may be provided with a lenticular lens of the convex lenses 13e that are arranged in the X-axis direction as illustrated in FIGS. 4A and 4B. Light distribution in the X-axis direction can be increased by increasing the contact angle between each convex lens 13e and the light outputting surface 13b.

Specifically, light distribution in the X-axis direction can be accurately controlled by adjusting the contact angle of each convex lens 13e and the light outputting surface 13b as appropriate. Thus, light distribution in the X-axis direction at the emission surface 5d of the light guide plate 5 can be accurately controlled. In addition, the pitch interval between the convex lenses 13e adjacent to each other can be made smaller than the pitch interval between the prisms 13d facing each other, thereby improving the uniformity of luminance in the X-axis direction.

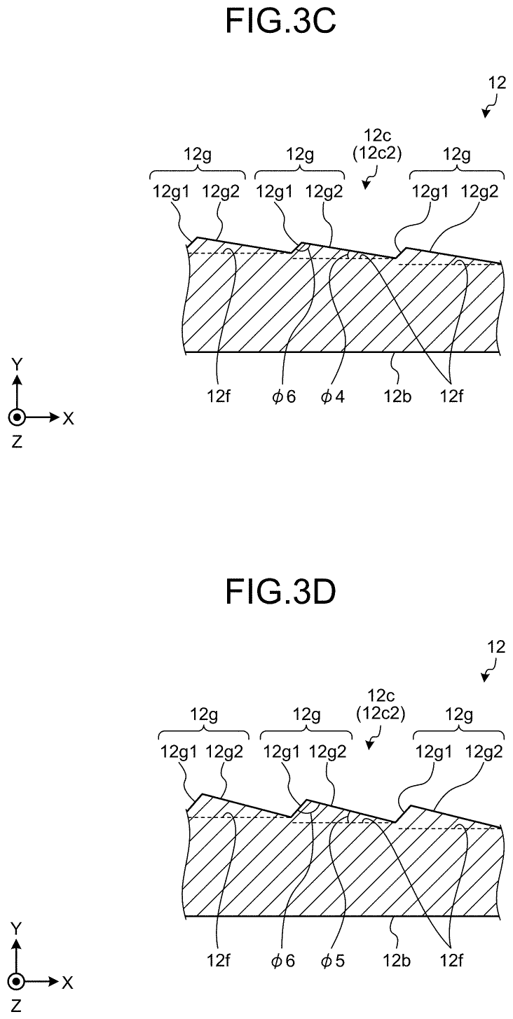

The following describes the visual field control film 4 according to the embodiment in detail with reference to FIG. 5A. FIG. 5A is a diagram for describing the visual field control film 4 according to the embodiment, specifically, a cross-sectional view along the XY plane.

The visual field control film 4 includes a light transmission part 4c as a base material, and a plurality of light absorption parts 4d. The light transmission part 4c has a light transmitting function and is made of, for example, optically transparent resin. Each light absorption part 4d has a light absorbing function and is made of, for example, light absorbing resin. The light absorption part 4d has a band shape and is disposed with the longitudinal direction thereof being aligned with a predetermined direction (for example, a peak direction P of light output from the prism sheet 13 in a sectional view along the XY plane).

Accordingly, as illustrated in FIG. 5A, for example, light 104 and light 105 each having a small degree of tilt relative to the peak direction P can transmit through the light transmission part 4c from the light incident surface 4a to the light outputting surface 4b, but light 106 having a large degree of tilt relative to the peak direction P is absorbed by the light absorption parts 4d and does not reach the light outputting surface 4b.

Accordingly, when the visual field control film 4 is provided, it is possible to prevent, from entering into the light guide plate 5, unnecessary light (for example, light 106) largely deviating from the peak direction P in a sectional view along the XY plane, in other words, at a section along a surface parallel to the emission surface 5d of the light guide plate 5. Accordingly, the X-axis directional light distribution property of light emitted in a direction changed through the light guide plate 5 can be improved.

In the embodiment, light may be output from the light outputting surface 4b of the visual field control film 4, in other words, light may be emitted from the linear light sources 3A and 3B and be entered into the light guide plate 5 at 20° or less at full width at half maximum in a sectional view along the XY plane. In addition, the visual field control film 4 may restrict the light distribution angle to the range of ±60° in a sectional view along the XY plane. Accordingly, the X-axis directional light distribution property of light emitted in a direction changed through the light guide plate 5 can be further improved.

In FIG. 5A, the peak direction P is parallel to the Y-axis direction, but not limited thereto. For example, as illustrated in FIG. 5B, when the peak direction P is tilted relative to the Y-axis direction, the longitudinal direction of each light absorption part 4d may be disposed at a tilt relative to the Y-axis direction in alignment with the peak direction P. FIG. 5B is a diagram for describing another example of the visual field control film 4 according to the embodiment. Accordingly, similarly to the example illustrated in FIG. 5A, it is possible to prevent transmission of light 106 at a large degree of tilt relative to the peak direction P.

In the embodiment, the housing frame 2 around the LEDs 11 and near the light incident surface 12a of the light bar 12 may be made of resin (for example, white resin) having a high reflectance. Accordingly, light efficiency can be improved. In addition, the housing frame 2 other than the above-described sites may be made of resin (for example, black resin) having a high absorbance. Accordingly, unnecessary light distribution can be reduced. In other words, the housing frame 2 may be formed by two-color molding of white resin and black resin.

In addition, in the planar illumination device 1 according to the embodiment, mirrored reflection of light may be achieved by a surface of the light bar 12 other than the light incident surface 12a and the light outputting surface 12b, a surface of the prism sheet 13 other than the light incident surface 13a and the light outputting surface 13b, and a surface of the light guide plate 5 adjacent to the side surface 5c and having a width of 2 mm approximately. For example, the surfaces may be covered with a mirrored reflection sheet having a C-shaped section. Accordingly, the light efficiency can be improved and unnecessary light distribution can be reduced.

In addition, the planar illumination device 1 according to the embodiment may be configured so that light is absorbed at terminal end part (lower end part in FIG. 1A) and side surface parts (right and left side surfaces in FIG. 1A) of the light guide plate 5. For example, these sites may be coated with a black coating material. Accordingly, unnecessary light distribution can be reduced.

(Modifications)

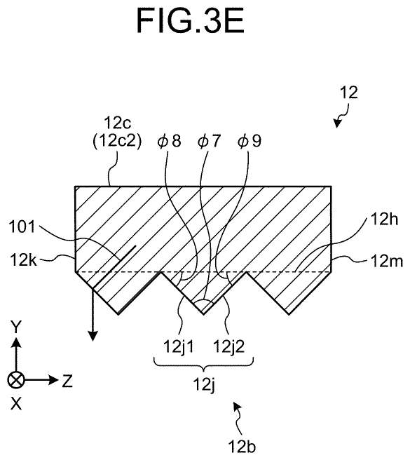

The following describes various modifications of the embodiment. In the following description, any site identical to that in the embodiment is denoted by an identical reference sign, and duplicate description thereof will be omitted in some cases. First, a first modification of the embodiment will be described with reference to FIGS. 6A and 6B.

FIG. 6A is a front view of the planar illumination device 1 according to the first modification of the embodiment, and FIG. 6B is an enlarged view of Region M in FIG. 6A. As illustrated in FIG. 6A, in the first modification, only one linear light source (the linear light source 3A) is provided unlike the embodiment in which a pair of linear light sources are provided.

In addition, as illustrated in FIG. 6B, the prisms 5f of the light guide plate 5 extend in a direction oblique to the predetermined direction B (from the X-axis positive direction and the Y-axis negative direction toward the X-axis negative direction and the Y-axis positive direction in the drawing). Accordingly, in the first modification, light can be emitted toward one desired direction (the X-axis positive direction and the Y-axis negative direction in the drawing) through the prisms 5f.

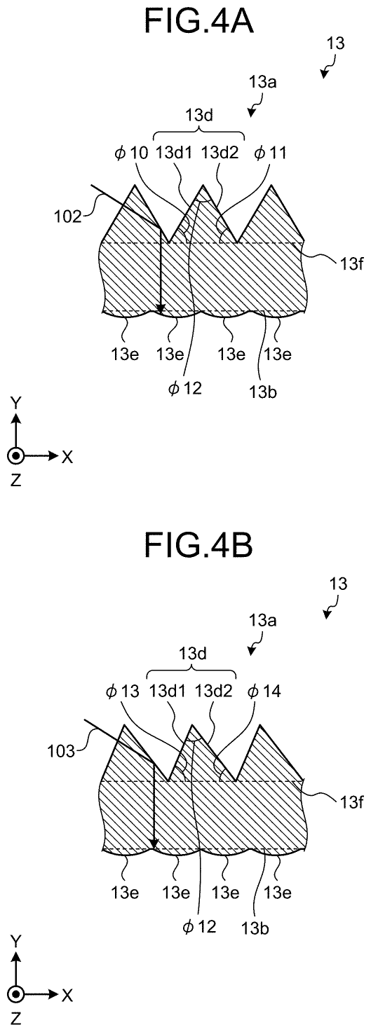

The following describes a second modification of the embodiment with reference to FIGS. 7A and 7B. FIG. 7A is an enlarged view of the first light guiding portion 5a according to the second modification of the embodiment, and FIG. 7B is an enlarged view of the second light guiding portion 5b according to the second modification of the embodiment. In other words, FIG. 7A is an enlarged view of Region D (refer to FIG. 1A) in the embodiment, and FIG. 7B is an enlarged view of Region E (refer to FIG. 1A) in the embodiment.

As illustrated in FIG. 7B, the prisms 5f of the second light guiding portion 5b extend in a direction oblique to the predetermined direction B similarly to the embodiment, but the prisms 5f of the first light guiding portion 5a extend in a direction orthogonal to the predetermined direction B as illustrated in FIG. 7A.

In this manner, since the prisms 5f are formed to extend in a direction orthogonal to the predetermined direction B as illustrated in FIG. 7A, the emission direction can be aligned with the predetermined direction B on the XY plane. In addition, since the prisms 5f of the second light guiding portion 5b are formed at a tilt relative to the predetermined direction B, light can be emitted in the emission direction in a tilted manner relative to the predetermined direction B on the XY plane.

In this manner, the emission direction of the planar illumination device 1 can be changed to two directions different from each other by changing the directions of the prisms 5f of the first light guiding portion 5a and the second light guiding portion 5b as appropriate.

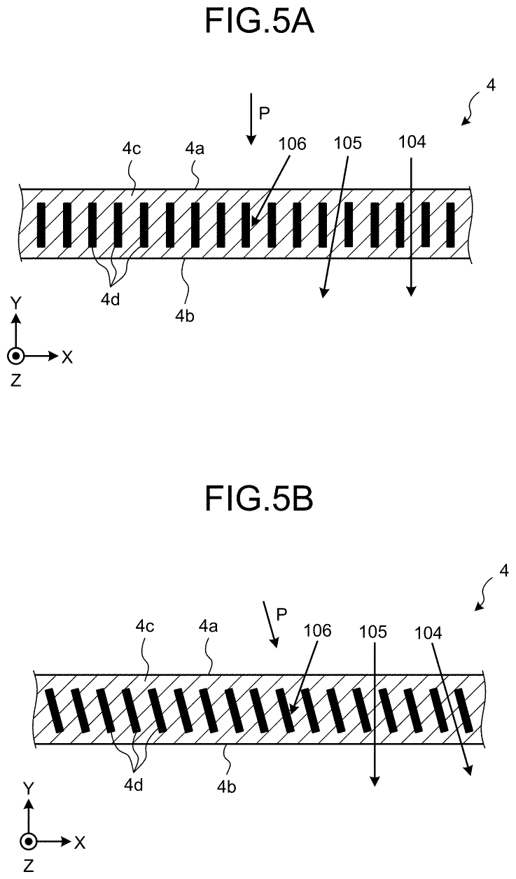

The following describes a third modification of the embodiment with reference to FIGS. 8 to 10B. FIG. 8 is a cross-sectional view of the planar illumination device 1 according to the third modification of the embodiment, and corresponds to FIG. 1B in the embodiment. The third modification is an example in which the visual field control film 4 in the embodiment is replaced with a visual field control film 4A having a different structure.

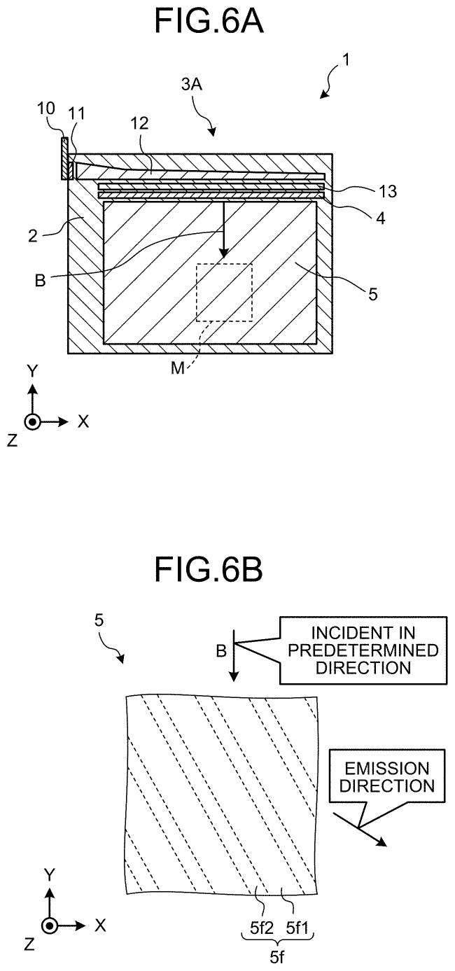

FIG. 9 illustrates the visual field control film 4A in detail. FIG. 9 is a diagram for describing the visual field control film 4A according to the third modification of the embodiment, specifically, a cross-sectional view along the YZ plane.

Similarly to the visual field control film 4, the visual field control film 4A includes the light transmission part 4c as a base material and the light absorption parts 4d. Unlike the visual field control film 4, each light absorption part 4d having a band shape is disposed so that the longitudinal direction thereof is aligned with the peak direction P of light output from the prism sheet 13 in a sectional view along the YZ plane.

Accordingly, as illustrated in FIG. 9, light 107 and light 108 having a small degree of tilt relative to the peak direction P in a sectional view along the YZ plane can transmit through the light transmission part 4c from the light incident surface 4a to the light outputting surface 4b. However, light 109 having a large degree of tilt relative to the peak direction P is absorbed by the light absorption parts 4d and does not reach the light outputting surface 4b.

Accordingly, when the visual field control film 4A is provided, it is possible to prevent unnecessary light (for example, light 109) that largely deviates from the peak direction P in a sectional view along the YZ plane, in other words, at a section along a surface orthogonal to the longitudinal direction of the visual field control film 4A, from entering the light guide plate 5.

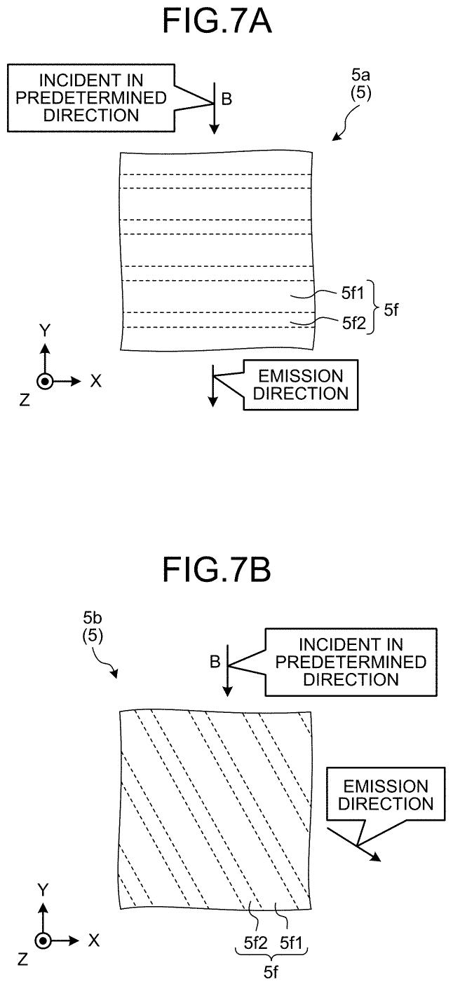

FIG. 10A is a diagram for describing light distribution in the planar illumination device 1 according to a reference example. Specifically, the reference example illustrated in FIG. 10A indicates the planar illumination device 1, in which no visual field control film 4A is provided.

As illustrated in FIG. 10A, when no visual field control film 4A is provided, the light 107 and the light 108 having small degrees of tilt relative to the peak direction P as well as the light 109 having a large degree of tilt relative to the peak direction P in a sectional view along the YZ plane are entered into the light guide plate 5. Then, the light 107 and the light 108 having small degrees of tilt relative to the peak direction P are reflected at the first region 5f1 and the second region 5f2 of each prism 5f inside the light guide plate 5, and emitted in a predetermined direction (the Y-axis negative direction and the Z-axis positive direction).

The light 109 having a large degree of tilt relative to the peak direction P is, on the other hand, repeatedly reflected at the emission surface 5d and the first region 5f1 of each prism 5f, is finally reflected at the second region 5f2 inside the light guide plate 5, and then is emitted in a direction (the Y-axis positive direction and the Z-axis positive direction) different from the predetermined direction.

Thus, when no visual field control film 4A is provided, it is difficult to improve the Y-axis directional light distribution property of light emitted in a direction changed through the light guide plate 5. In other words, with the reference example, the driver on the Y-axis positive direction side and a person seated on the passenger seat potentially feel dazzling.

FIG. 10B is a diagram for describing light distribution in the planar illumination device 1 according to the third modification of the embodiment. As illustrated in FIG. 10B, when the visual field control film 4A is provided, the light 107 and the light 108 having small degrees of tilt relative to the peak direction P in a sectional view along the YZ plane are entered into the light guide plate 5, but the light 109 having a large degree of tilt relative to the peak direction P is not incident.

Accordingly, light emitted in a direction (the Y-axis positive direction and the Z-axis positive direction) different from the predetermined direction attributable to the light 109 can be reduced. Thus, according to the third modification, it is possible to improve the Y-axis directional light distribution property of light emitted in a direction changed through the light guide plate 5.

In the third modification, light may be output from the light outputting surface 4b of the visual field control film 4A, in other words, from the linear light sources 3A and 3B to the light guide plate 5 at 20° or less at full width at half maximum in a sectional view along the YZ plane. In addition, the visual field control film 4A may restrict the light distribution angle to the range of ±60° in a sectional view along the YZ plane, and more preferably, to the range of ±45°. Accordingly, the Y-axis directional light distribution property of light emitted in a direction changed through the light guide plate 5 can be further improved.

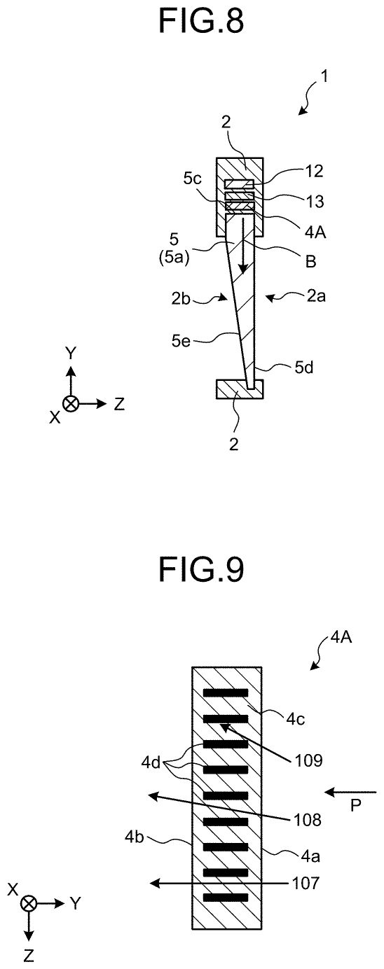

FIG. 11 is a cross-sectional view of the planar illumination device 1 according to a fourth modification of the embodiment. The fourth modification is an example in which the visual field control film 4 provided in the embodiment and the visual field control film 4A provided in the third modification are both used.

Specifically, as illustrated in FIG. 11, the visual field control film 4 and the visual field control film 4A are disposed in a stacking manner between the prism sheet 13 and the light guide plate 5. In the fourth modification, the X-axis directional light distribution property of light emitted in a direction changed through the light guide plate 5 can be improved through the visual field control film 4, and the Y-axis directional light distribution property of light emitted in a direction changed through the light guide plate 5 can be improved through the visual field control film 4A.

In the fourth modification, the visual field control film 4 and the visual field control film 4A may be directly bonded to each other preferably. Accordingly, refractive index change between the visual field control film 4 and the visual field control film 4A is reduced, which leads to reduction of light attenuation between the visual field control film 4 and the visual field control film 4A. As a result, the light emission efficiency of the planar illumination device 1 is improved.

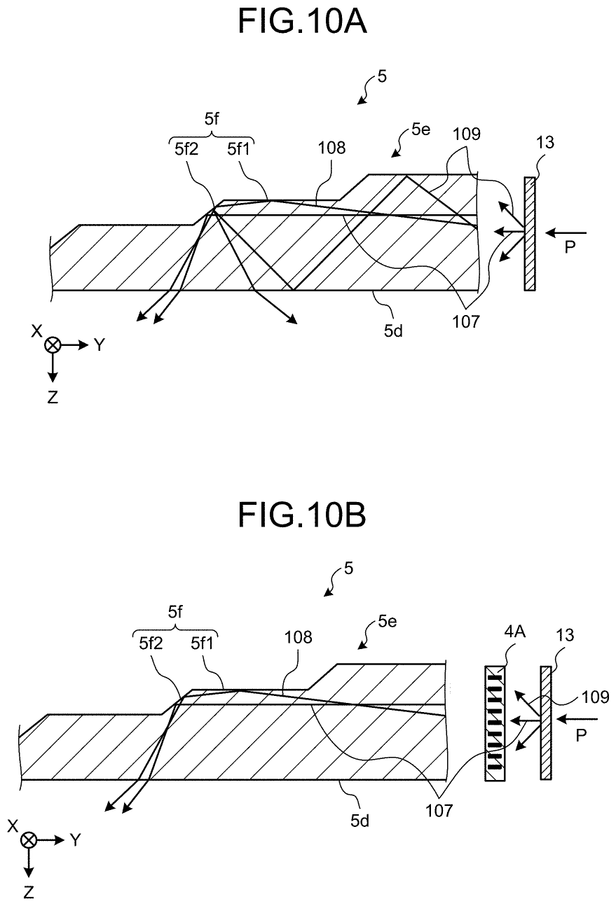

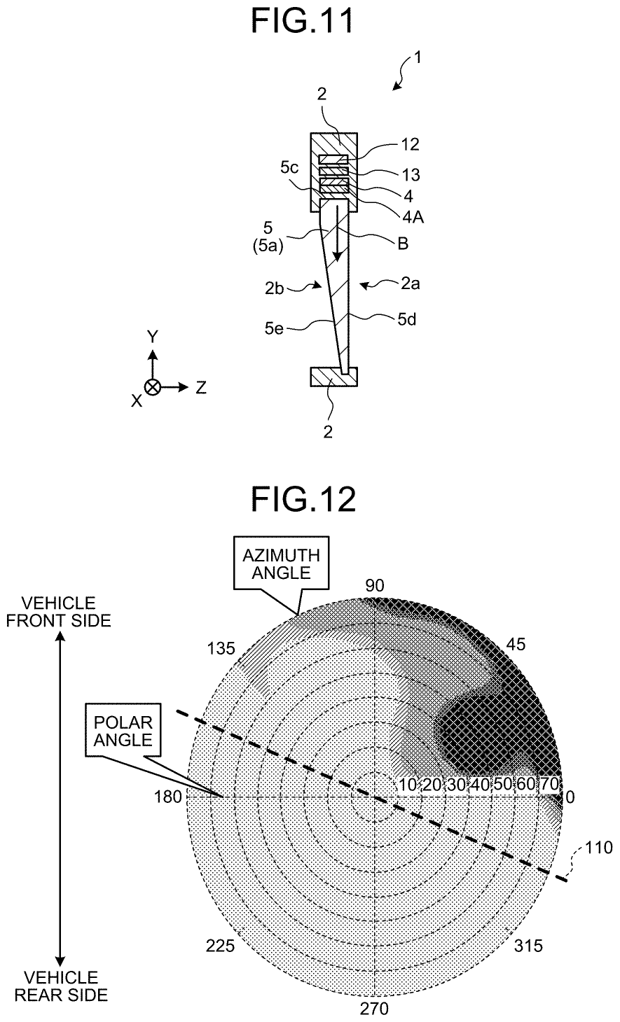

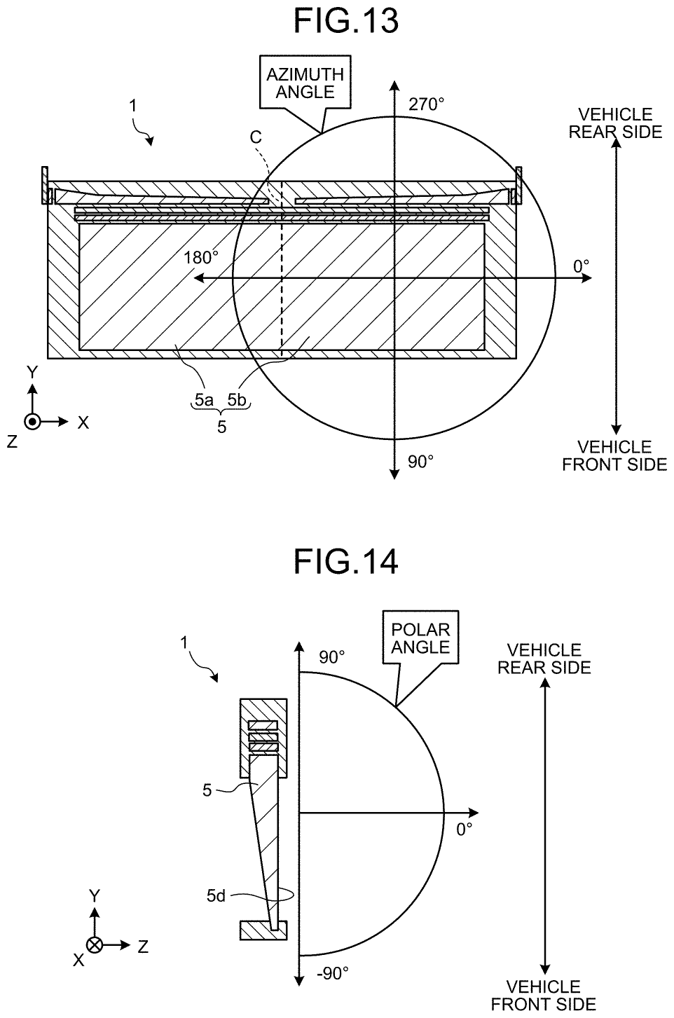

FIG. 12 is a diagram illustrating light distribution in the planar illumination device 1 according to the reference example. In the light distribution illustrated in FIG. 12, a darker color indicates a larger luminance. The directions of an azimuth angle and a polar angle in the light distribution illustrated in FIG. 12 will be described with reference to FIGS. 13 and 14.

FIG. 13 is a diagram for describing the azimuth angle in the light distribution illustrated in FIG. 12. As illustrated in FIG. 13, in the light distribution illustrated in FIG. 12, light emitted from the second light guiding portion 5b of the light guide plate 5 has an X-axis positive direction at the azimuth angle of 0°, a Y-axis negative direction at the azimuth angle of 90°, an X-axis negative direction at the azimuth angle of 180°, and a Y-axis positive direction at the azimuth angle of 270°. The azimuth angle of 90° (the Y-axis negative direction) corresponds to the front side of the vehicle, and the azimuth angle of 270° (the Y-axis positive direction) corresponds to the rear side of the vehicle.

FIG. 14 is a diagram for describing the polar angle in the light distribution illustrated in FIG. 12. As illustrated in FIG. 14, in the light distribution illustrated in FIG. 12, light emitted from the emission surface 5d of the light guide plate 5 has a Z-axis positive direction at the polar angle of 0°, a direction orthogonal to the Z-axis positive direction at the polar angle of 90°, and a direction opposite to the orthogonal direction at the polar angle of −90°. For example, as illustrated in FIG. 14, when the polar angle of 90° is the Y-axis positive direction, the polar angle of −90° is the Y-axis negative direction.

Description of FIG. 12 continues. As illustrated in FIG. 12, the planar illumination device 1 according to the reference example emits light toward a predetermined direction centered at the azimuth angle of 25° approximately and the polar angle of 50° approximately. However, the planar illumination device 1 according to the reference example emits light also in a direction different from the predetermined direction.

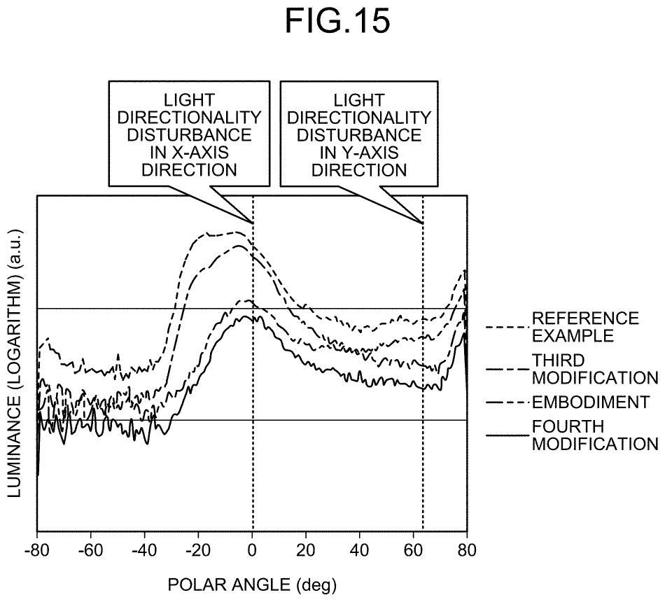

FIG. 15 is a diagram illustrating light distribution sections in the embodiment, the third modification, the fourth modification, and the reference example. Specifically, FIG. 15 illustrates the luminance of sections at the azimuth angle of 337° approximately (corresponding to a dashed line 110 in FIG. 12) in luminance distribution in a hemisphere direction having the polar angle of 0° in the Z-axis positive direction illustrated in FIG. 12.

In FIG. 15, the luminance becomes high in a region near the polar angle of 0° when light distribution is disturbed in the X-axis direction, and the luminance becomes high in a region near the polar angle of 63° when light distribution is disturbed in the Y-axis direction.

As illustrated in FIG. 15, in the reference example in which no visual field control film 4 nor visual field control film 4A are provided, the luminance is high near the polar angles of 0° and 63°, which indicates that light distribution is disturbed somewhat in the X-axis direction and the Y-axis direction.

In the embodiment in which the visual field control film 4 is provided, the luminance decreases near the polar angle of 0° as compared to the reference example, which indicates improvement of the light distribution property in the X-axis direction.

In the third modification in which the visual field control film 4A is provided, the luminance decreases near the polar angle of 63° as compared to the reference example, which indicates improvement of the light distribution property in the Y-axis direction.

In the fourth modification in which the visual field control film 4 and the visual field control film 4A are both provided, the luminance decreases near the polar angle of 0° and the polar angle of 63° as compared to the reference example, which indicates improvement of the light distribution property in the X-axis direction and the Y-axis direction.

As described above, according to the embodiment, it is possible to achieve both a translucent property and a high light distribution property since the back surface 5e of each prism 5f formed on the light guide plate 5 includes, at a section parallel to the predetermined direction B, the first region 5f1 substantially parallel to the emission surface 5d, and the second region 5f2 tilted relative to the emission surface 5d, and the first region 5f1 and the second region 5f2 are formed to extend in a direction oblique to the predetermined direction B.

The linear light sources 3A and 3B are formed by using the LEDs 11 and the light bars 12 in the above-described embodiment, but the configuration of the linear light sources is not limited to such an example. For example, a plurality of LEDs may be arranged in line to form a linear light source. In addition, the planar illumination device 1 is formed symmetrically with respect to Center C in the above-described embodiment, but the planar illumination device 1 does not need to be symmetrically formed.

The configuration of the prism sheet 13 is symmetric in the right-left direction in the above-described embodiment, but the configuration of the prism sheet 13 may be different in the right-left direction. With this configuration, light in directions different from each other can be entered into the first light guiding portion 5a and the second light guiding portion 5b of the light guide plate 5. In addition, the prism sheet 13 is integrally formed in the above-described embodiment, but the prism sheet 13 may be divided in a right-left direction, similarly to the light bars 12.

As described above, the planar illumination device 1 according to the embodiment includes a light source (the linear light source 3A or 3B) and the light guide plate 5. The light source (linear light source 3A or 3B) emits light in the predetermined direction B. The light guide plate 5 includes the side surface 5c, the emission surface 5d as one of principal surfaces, and the back surface 5e as the other principal surface, is provided with the prisms 5f formed on the back surface 5e, and emits, through the emission surface 5d, light entered from the side surface 5c from the light source (linear light source 3A or 3B). Each prism 5f includes, at a section parallel to the predetermined direction B, the first region 5f1 substantially parallel to the emission surface 5d, and the second region 5f2 tilted relative to the emission surface 5d, the first region 5f1 and the second region 5f2 extending in a direction oblique to the predetermined direction B. With this configuration, it is possible to achieve both a translucent property and a high light distribution property.

In the planar illumination device 1 according to the embodiment, light is emitted from the emission surface 5d in the range of 40° or less at full width at half maximum. With this configuration, it is possible to sufficiently irradiate a necessary region and further reduce irradiation of an unnecessary region.

The planar illumination device 1 according to the embodiment further includes the visual field control film 4 disposed between the light source (linear light source 3A or 3B) and the side surface 5c of the light guide plate 5 and configured to restrict the light distribution angle. With this configuration, it is possible to improve the light distribution property of light emitted in a direction changed through the light guide plate 5.

In the planar illumination device 1 according to the embodiment, the visual field control film 4 restricts the light distribution angle relative to a predetermined direction to the range of ±60° or less (preferably, ±45° or less) at a section along a surface parallel to the emission surface 5d. With this configuration, it is possible to further improve the X-axis directional light distribution property of light emitted in a direction changed through the light guide plate 5.

In the planar illumination device 1 according to the embodiment, the visual field control film 4A restricts the light distribution angle to the range of ±60° or less (preferably, ±45° or less) at a section along a surface orthogonal to the longitudinal direction. With this configuration, it is possible to further improve the Y-axis directional light distribution property of light emitted in a direction changed through the light guide plate 5.

In the planar illumination device 1 according to the embodiment, the light source is the linear light source 3A or 3B extending along the side surface 5c. With this configuration, planar light can be emitted from the light guide plate 5.

In the planar illumination device 1 according to the embodiment, the two linear light sources 3A and 3B are disposed along the side surface 5c. With this configuration, it is possible to independently emit light to two places (for example, the driver seat side and the passenger seat side) different from each other.

In the planar illumination device 1 according to the embodiment, the light guide plate 5 includes the first light guiding portion 5a and the second light guiding portion 5b, and the direction in which the first region 5f1 and the second region 5f2 extend is different between the first light guiding portion 5a and the second light guiding portion 5b. With this configuration, it is possible to emit light at a high light distribution property to two places (for example, the driver seat side and the passenger seat side) different from each other.

The present invention is not limited to the above-described embodiment. The present invention also includes appropriate combinations of components described above. Further effects and modifications could be easily thought of by the skilled person in the art. Thus, a wider aspect of the present invention is not limited to the above-described embodiment but may include various changes.

### REFERENCE SIGNS LIST

1 planar illumination device
2 housing frame
3A, 3B linear light source
4, 4A visual field control film
5 light guide plate
5a first light guiding portion
5b second light guiding portion
5c side surface
5d emission surface
5e back surface
5f prism
5f1 first region
5f2 second region
10 FPC
11 LED (light source)
12 light bar
13 prism sheet

1. A planar illumination device comprising:
a light source configured to emit light in a predetermined direction; and
a light guide plate including a side surface, an emission surface as one of principal surfaces, and a back surface as the other principal surface, the back surface including a prism formed thereon, the light guide plate emitting, through the emission surface, light emitted from the light source and entered from the side surface, wherein
the prism includes, at a section parallel to the predetermined direction, a first region substantially parallel to the emission surface and a second region tilted relative to the emission surface, the first region and the second region extending in a direction oblique to the predetermined direction.

2. The planar illumination device according to claim 1, wherein light is emitted from the emission surface in a range of 40° or less at full width at half maximum.

3. The planar illumination device according to claim 1, further comprising a visual field control film disposed between the light source and the side surface of the light guide plate and configured to restrict a light distribution angle.

4. The planar illumination device according to claim 3, wherein the visual field control film restricts the light distribution angle to a range of ±60° at a section along a surface parallel to the emission surface.

5. The planar illumination device according to claim 3, wherein the visual field control film restricts the light distribution angle to a range of ±60° at a section along a surface orthogonal to a longitudinal direction.

6. The planar illumination device according to claim 1, wherein the light source is a linear light source extending along the side surface.

7. The planar illumination device according to claim 6, wherein two of the linear light sources are disposed along the side surface.

8. The planar illumination device according to claim 1, wherein the light guide plate includes a first light guiding portion and a second light guiding portion, and a direction in which the first region and the second region extend is different between the first light guiding portion and the second light guiding portion.

9. The planar illumination device according to claim 2, further comprising a visual field control film disposed between the light source and the side surface of the light guide plate and configured to restrict a light distribution angle.

10. The planar illumination device according to claim 4, wherein the visual field control film restricts the light distribution angle to a range of ±60° at a section along a surface orthogonal to a longitudinal direction.

11. The planar illumination device according to claim 2, wherein the light guide plate includes a first light guiding portion and a second light guiding portion, and a direction in which the first region and the second region extend is different between the first light guiding portion and the second light guiding portion.

12. The planar illumination device according to claim 3, wherein the light guide plate includes a first light guiding portion and a second light guiding portion, and a direction in which the first region and the second region extend is different between the first light guiding portion and the second light guiding portion.

13. The planar illumination device according to claim 4, wherein the light guide plate includes a first light guiding portion and a second light guiding portion, and a direction in which the first region and the second region extend is different between the first light guiding portion and the second light guiding portion.

14. The planar illumination device according to claim 5, wherein the light guide plate includes a first light guiding portion and a second light guiding portion, and a direction in which the first region and the second region extend is different between the first light guiding portion and the second light guiding portion.

15. The planar illumination device according to claim 6, wherein the light guide plate includes a first light guiding portion and a second light guiding portion, and a direction in which the first region and the second region extend is different between the first light guiding portion and the second light guiding portion.

16. The planar illumination device according to claim 7, wherein the light guide plate includes a first light guiding portion and a second light guiding portion, and a direction in which the first region and the second region extend is different between the first light guiding portion and the second light guiding portion.

17. A planar illumination device comprising:
a plurality of light sources configured to emit light in a predetermined direction; and
a light guide plate including a side surface, an emission surface as one of principal surfaces, and a back surface as the other principal surface, the back surface including a prism formed thereon, the light guide plate emitting, through the emission surface, light emitted from the light source and entered from the side surface, wherein
the light guide plate includes a plurality of regions disposed along the side surface, and a crossing angle between the predetermined direction that each of the light sources emits light and a direction in which the prism extends are different from each other is different between each of the regions.

18. The planar illumination device according to claim 17, wherein
the light sources are disposed along the side surface, and
light emitted from each of the light sources enters into each of the regions whose side surface faces the light source emitting the light.
